(19) United States
(12) Patent Application Publication
(10) Pub. No.: US 2015/0159035 A1
(43) Pub. Date: Jun. 11, 2015

(54) SUBCRITICALLY FORMULATED COATINGS

(71) Applicants: Jan Hendrik Schattka, Darmstadt (DE); Thomas Matten, Bergisch Gladbach (DE); Stephan Fengler, Frankfurt (DE); Wernfried Heilen, Alpen (DE); Florian Hermes, Frankfurt (DE); Herbert Jung, Karlstein (DE)

(72) Inventors: Jan Hendrik Schattka, Darmstadt (DE); Thomas Matten, Bergisch Gladbach (DE); Stephan Fengler, Frankfurt (DE); Wernfried Heilen, Alpen (DE); Florian Hermes, Frankfurt (DE); Herbert Jung, Karlstein (DE)

(73) Assignee: EVONIK DEGUSSA GMBH, Essen (DE)

(21) Appl. No.: 14/413,502

(22) PCT Filed: Jul. 10, 2013
(86) PCT No.: PCT/EP2013/064564

§ 371 Date: Jan. 8, 2015

(30) Foreign Application Priority Data
Aug. 7, 2012 (DE) 10 2012 213 978.8

(51) Int. Cl. C09D 133/06; C09D 133/02; C09D 125/06

(52) U.S. Cl. CPC C09D 133/064; C09D 125/06; C09D 133/02; C09D 133/06

(57) ABSTRACT

The present invention relates to dispersion-based paints or varnishes, more particularly for use as coating material (architectural paint), which have a low pigment volume concentration (PVC), lower than the critical pigment volume concentration (CPVC). The varnishes have high water vapour permeability and low water absorption.

They are notable for good weathering resistance and resistance to wet abrasion, shade stability and chalking stability, and a variable, adjustable gloss.

### FIELD OF THE INVENTION

The present invention relates to aqueous dispersion-based paints and varnishes, more particularly for use as architectural paint, that have a low pigment volume concentration (PVC), less than the critical volume concentration (CPVC) of the paints and varnishes. Nevertheless, in contrast to the prior art, the dispersion-based paints and varnishes of the invention have a high water vapour permeability and low water absorption. Furthermore, they are notable for good weathering resistance, shade stability and chalking stability, and mechanical resistance, such as good wet abrasion. The gloss of this coating material can be adjusted from very matt to glossy.

### PRIOR ART

The development of an optimized architectural paint, especially for exterior applications, has long been a goal of industrial development. Many of the properties of an architectural paint can be adjusted via the pigment volume concentration. The pigment volume concentration is an arithmetic description of the fraction of fillers and pigments as a proportion of the total volume of the dried coating:

% PVC=(volume of pigments and fillers×100)/(volume of binder+volume of pigments and fillers)

As the PVC goes up, therefore, the binder fraction goes down. The critical pigment volume concentration is the precise level at which all of the interstices between pigments and/or fillers are still filled with binder. In this way, accordingly, a coherent film is formed. Only when the CPVC is exceeded does the film become open-pored, producing cavities. If the PVC is increased further, the binder then functions only as a kind of glue between the pigments and/or fillers. As the skilled person is aware, the CPVC is dependent on the size of the fillers, and so the term is not used in the case, for example, of very coarse filling material. Exceedance of the CPVC is accompanied by drastic changes in numerous coating properties. For instance, in particular, there is a sharp rise in the permeability of the paints for water and water vapour, while the gloss and the wet abrasion resistance go down.

Dispersion-based paints—i.e. emulsion paints—with a high pigment volume concentration (PVC) which is greater than the critical pigment volume concentration (CPVC) exhibit increased surface roughness and therefore have a matt appearance. As a result of the high level of filling, these coatings are open-pored and therefore exhibit good—i.e. high—water vapour permeability. Because of the low binder fraction, paints of this kind have weaknesses in shade stability and chalking stability and also mechanical resistance. Low water absorption is achieved, as the skilled person is aware, through the use, for example, of waxes, silicone resins or aminosiloxanes.

Paints and varnishes formulated subcritically have the abovementioned good properties and resistances, but the water vapour permeability of the paint films is inadequate (s_{d}>0.25 m).

The CPVC is determined using the sharp change in properties, such as the sharp increase in water vapour permeability, for example. Another possibility is the so-called Gilsonite test, which exploits the absorption of a test liquid in the pores. Accordingly, a porous coating film exhibits irreversible absorption of a Gilsonite solution at above the CPVC, and so the CPVC can be ascertained from an incipient discoloration. The Gilsonite test was carried out in accordance with “KRONOS Titandioxid in Dispersionsfarben” [KRONOS titanium dioxide in emulsion paints], H. Dörr, F. Holzinger, KRONOS Titan GmbH, Leverkusen, Germany, 1989.

A hitherto unsolved problem is that of providing dispersion-based paints and varnishes which on the one hand exhibit good shade stability (even for mass tones) and good chalking stability, while at the same time exhibiting a low pigment volume concentration (<CPVC) and a high water vapour permeability.

Strauss et al. (Surface Coatings Australia 1987, 24(11), 6-15) describe the use of emulsion polymers of the Ropaque type (from Rohm & Haas) in masonry paints. The purpose of using them, however, was not to improve the water vapour permeability, but to increase the hiding power of a coating. Furthermore, as explicitly observed in Strauss et al., the stated products do not film at room temperature.

The preparation of the core-shell-structured emulsion polymers used therein, also referred to thereafter as hollow beads, is described in EP 0 022 633. These particles are explicitly not film-forming at a temperature of 20° C. These hollow beads act exclusively as pigment or matting agent, and in the shell have a glass transition temperature of at least 50° C.

WO 2011/009875A1 describes the use of film-forming polymers and organic hollow particles for coating compositions, with the purpose of raising the coverage and the wet abrasion resistance of exterior and interior paints. WO 2007/006766 describes a similar production operation. Both specifications describe multi-stage emulsion polymers whose outer shells have a glass transition temperature, according to Fox, of at least 50° C., and whose outer shells envelop the inner shells.

Object

Against this background, an object of the present invention was to produce dispersion-based paints and varnishes which simultaneously have good water vapour permeability and exhibit no visual disadvantages and also no reduced service properties relative to the prior art.

A further object of the present invention was that the dispersion-based varnish should be distinguished by high gloss and good weathering resistance, shade stability and, in particular, good wet abrasion resistance.

A further object of the present invention was that the dispersion-based paints subcritically formulated should exhibit good weathering resistance, more particularly a shade stability.

It was an object of the present invention, furthermore, to ensure a readily technically accomplishable production and usefulness on the part of the dispersion-based paints and varnishes.

Further objects, not explicitly stated, may become apparent from the following description, the claims or the working examples, without requiring express statement to that effect.

Achievement

The object has been achieved through use of polymeric microparticles, having a cavity, in dispersion-based varnishes, for the purpose of improving the water vapour permeability. Particular features of these are that the dispersion-based varnish comprises at least 3.0 wt %, preferably 5 wt % and more preferably at least 10 wt % of the polymeric microparticles with hydrophilic domains, and that the pigment volume concentration (PVC) of the paint is less than the CPVC.

Figures in wt % for the swollen polymers refer in this specification—unless expressly indicated otherwise—to the solids content of 100% of the overall formulation, with the exception of the water.

The objects have also been achieved through the use of multi-stage emulsion polymers which comprise acid groups in an least one polymerization stage. The fraction of unsaturated, acid-functional monomers is preferably more than 5%, more preferably more than 30% and very preferably more than 45%, based on the monomers in this polymerization stage. The shell has a glass transition temperature of below 50° C. A preferred glass transition temperature for the shell is below 30° C., more preferably a glass transition temperature of below 20° C. The emulsion polymers, moreover, preferably have a diameter of between 30 nm and 1200 nm, more preferably between 50 nm and 600 nm and very preferably between 60 nm and 300 nm. The particle size is determined by measuring and counting a statistically significant quantity of particles on the basis of transmission electron micrographs.

The emulsion polymers used in accordance with the invention are notable in particular for the fact that the cavity forms in the emulsion polymers by swelling at a temperature above 0° C. and below 50° C., preferably at room temperature.

The term “hollow bead” for the purposes of this invention does not automatically describe microparticles which comprise a cavity. The term “cavity” describes hydrophilic domains within the polymeric microparticles that may be partly swollen, with water, for example. This reduction in the polymer concentration in these regions of the microparticles leads to them being designated hollow beads. Methods for producing hollow beads are described in references including C. J. McDonald and M. J. Devon in Advances in Colloid and Interface Science, Volume 99, Number 3, Pages 181-213. In the finished film, the particles may at least partly lose their particulate character, since at least the shell together with the binder forms a film.

In accordance with the invention the emulsion polymer used can be prepared by means of emulsion polymerization in two successive stages. This preparation is generally accomplished by means of sequential addition of the monomer mixtures. The first stage, though, can also be prepared separately, optionally purified, and used as seed latex for the second stage in a second emulsion polymerization. The polymer core (A) here is prepared with copolymerization of one or more unsaturated, acid-functional monomers, optionally with other, non-functional monomers and/or with crosslinking difunctional monomers. The polymer shell (B) is composed predominantly of non-ionic, ethylenically unsaturated monomers. Particle nucleation may be accomplished, optionally, by addition of a seed latex. The polymer shell (B) is preferably characterized in that it comprises at least 0.5 wt % of a crosslinking difunctional monomer.

The polymer core is preferably swollen subsequently by means of one or more aqueous basic adjuvants. This swelling may take place at different points in time, such as directly following the synthesis, for example, but more preferably in the completed formulation. In the formulation, even without addition of hollow beads, the pH established is preferably >5, more preferably >7. For the neutralization it is necessary at least in part to employ bases which are non-volatile at room temperature, more particularly bases having a boiling point of at least 110° C., such as alkali metal hydroxides or alkaline earth metal (hydr)oxides, for example. The degree of neutralization, i.e. the number of deprotonated carboxylate groups, based on the acid groups used, is to be using a mixture of volatile and non-volatile bases, such as ammonia and sodium hydroxide, for example.

The unsaturated, acid-functional monomers are anhydrides or acids copolymerizable with (meth)acrylates, and are preferably acrylic acid, methacrylic acid, maleic acid, fumaric acid, itaconic acid and/or crotonic acid. An alternative possibility is to use hydrolysable functionalities such as unsaturated anhydrides, more particularly maleic anhydride.

The nonionic, ethylenically unsaturated monomers in the polymer shell and in the polymer core are preferably acrylates, methacrylates, styrene and/or mixtures composed predominantly of acrylates and/or methacrylates and/or styrene. Alternatively the mixtures may also include butadiene, vinyltoluene, ethylene, vinyl acetate, vinyl chloride, vinylidene chloride, acrylonitrile, acrylamide or methacrylamide. The acrylates and/or methacrylates—referred to collectively below using the term (meth)acrylates—are preferably C1-C12-alkyl esters of (meth)acrylic acid or mixtures thereof.

In one alternative embodiment the microparticles have a structure in which at least two shells, B1 and B2, are arranged around the core. The shells are likewise realized sequentially or by the seed latex method, and may be the same as or different from one another in their composition. The polymer shells, in analogy to a single shell B, are composed in each case predominantly of nonionic, ethylenically unsaturated monomers. Core-shell particles may be prepared whose shells have a gradient. The polymer shells comprise the innermost shell B1 and the second and, optionally, further shells B2, B3, etc., with increasing distance from the core.

The preparation of these polymeric microparticles by means of emulsion polymerization and also their swelling using bases such as, for example, alkali metal hydroxides or alkaline earth metal hydroxides, and also ammonia or an amine, are likewise described in European patents EP 0 022 633 B1, EP 0 073 529 B1 and EP 0 188 325 B1. In the case of preparation by emulsion polymerization, the microparticles are obtained in the form of an aqueous dispersion. Accordingly, the microparticles are preferably likewise added in this form to the dispersion-based varnish. In the formulation of the varnish, and also in the varnish itself, the cavities in the microparticles are optionally water-filled. Without restricting the invention in this way, it is assumed that the water is lost—at least partly—from the particles, when the dispersion-based varnish is filled, after which, accordingly, gas- or air-filled hollow beads or else collapsed microparticles remain.

The dispersion-based paints and varnishes furnished inventively with microparticles are used preferably as architectural paints or varnishes. For this purpose the dispersion-based varnish comprises at least 3.0 wt %, more particularly at least 5.0 wt % and preferably at least 10.0 wt % of the microparticles in the form of swollen emulsion polymers for improving the water vapour permeability.

The binders may be polyacrylates, polymethacrylates, polystyrenes, copolymers of acrylates, methacrylates and/or styrenes, polyvinyl acetate, polyacrylonitrile, polyethers, polyesters, polylactic acids, polyamides, polyesteramides, polyurethanes, polycarbonates, amorphous or semi-crystalline poly-a-olefins, EPDM, EPM, hydrogenated or unhydrogenated polybutadienes, ABS, SBR, polysiloxanes and/or block, comb and/or star copolymers of these polymers.

The binders are preferably polyacrylates, styrene-acrylates or polyvinyl acetates.

The outer shell or one of the outer shells of the hollow beads is more preferably selected such that joint film formation with the binder takes place. If the polymeric microparticles have been furnished with a large fraction of film-forming shell, it is possible to do without the addition of a binder.

Likewise part of the present invention is the production of dispersion-based paints and varnishes which in accordance with the described use have been furnished with microparticles, more particularly with emulsion polymers and very preferably with (meth)acrylate-based emulsion polymers having a core-shell structure. These core-shell particles are—as described—core-shell particles furnished with an acid-containing core, which can be swollen basically at room temperature, and with a shell having a glass transition temperature of below 50° C.

Besides the binders and the emulsion polymers used in accordance with the invention, diluents may be present as a further constituent in the dispersion-based varnishes. These diluents are generally water or mixtures of water and other polar solvents such as, for example, water-miscible glycol ethers and their acetates or high-boiling esters of dicarboxylic acids.

Besides the emulsion polymers used in accordance with the invention, optional diluents and the binders, dispersion-based varnishes of these kinds may comprise various further components. These additional components may be adjuvants selected specifically for the particular application, such as, for example, fillers, dyes, pigments, additives, compatibilizers, cobinders, cosolvents, plasticizers, impact modifiers, thickeners, defoamers, dispersing additives, rheology improvers, adhesion promoters, preservatives, scratchproofing additions, catalysts or stabilizers.

Depending, for example, on the diameter, the core/shell ratio and the swelling efficiency, the polymer content of the microparticles used may be 2 to 100 vol %.

The examples which follow do not in any way restrict the present invention in any form whatsoever. Their purpose, rather, is to illustrate the technical effect of the present invention, using exemplary compositions.

### EXAMPLES

Determination of Film Porosity (Gilsonite Test)
The paint is applied to a Leneta sheet (PVC film) using a four-way bar applicator (200 pm wet film). After drying in an oven at 50° C., the sheet is immersed halfway for 7 seconds in a 10% strength Gilsonite solution (solution of a natural asphalt). Immediately thereafter it is washed with white spirit and wiped down with a highly absorbent cloth. The difference in lightness (ΔL*) between the half immersed in Gilsonite solution and the unmodified area is determined using an X-Rite spectrophotometer.

Determination of Glass Transition Temperature
The glass transition temperatures were determined by theoretical calculation by means of the Fox equation.

Determination of pH
The pH is determined using the precision pH meter from Hanna Instruments.

Determination of Water Absorption
The water absorption (W₂₄) is determined in accordance with EN 1062-3 with a paint application rate of 400 mL/m².

Determination of Water Vapour Diffusion
The water vapour diffusion (s_{d}) is determined in accordance with EN ISO 7783-2 with a paint application rate of 400 mL/m².

Measurement of Gloss at 20°
For measurement of the gloss, the paint is applied to a glass plate, using a 200 μm four-way bar applicator. After drying at room temperature, the gloss is measured using the haze-gloss reflectomer from Byk Gardner.

ASTM (Strokes)
The measurement is performed in accordance with ASTM D 2486. The paint is applied in a wet film thickness of 200 μm to a black plastic sheet and dried at room temperature for 7 days. The sheet is then scrubbed with the model 494 scrub tester from Erichsen, equipped with a nylon brush, until damage over the scrubbing strip becomes apparent. An abrasive detergent fluid is used in order to accelerate the test process.

Production of Hollow Bead Dispersions

### Example 1

### Preparation of Seed Latex

The monomer emulsion is prepared by charging a conical flask with 450 g of methyl methacrylate, 5.38 g of Disponil SUS IC 875 (emulsifier based on diisooctyl suiphosuccinate) and 193 g of deionized water. The mixture is stirred vigorously for a minute, and after a rest time of five minutes is stirred vigorously for a further ten minutes until complete formation of an emulsion. A 1 L reactor is charged with 4.22 g of Disponil SUS IC 875 and 360 g of deionized water and this initial charge is heated to an internal temperature of 74° C. with stirring at 150 rpm and with N₂ being passed over it. When the reaction temperature is reached, 51 g of the emulsion are pumped quickly into the Quickfit flask. Then the initiating reactants—2.1 mL of 10% strength aqueous sodium peroxodisulphate solution and 2.0 ml of 10% strength aqueous sodium hydrogen sulphite solution—are added.

Immediately there is an increase in temperature with a temperature peak of around 80° C. After a waiting time of one minute, further monomer emulsion is metered in, at a metering rate of 3.0 g/min, for ten minutes more. Within this time, the internal temperature is lowered to 75° C. Metering of monomer emulsion takes place then for a further 82 minutes at a rate of 6.9 g/min. The process temperature is maintained at 75° C.±1° C. during the metered feed. After an after-reaction time of 30 minutes, the dispersion is cooled to RT and filtered through a 250 μm gauze.

### Example 2

### Preparation of the Hollow Bead Dispersion

For the first reaction stage a monomer mixture consisting of 35.3 g of methyl methacrylate, 25.5 g of methacrylic acid and 3.2 g of n-butyl acrylate is prepared. For the second reaction stage an emulsion is prepared from the following components: 161.15 g of methyl methacrylate (MMA), 161.15 g of ethylhexyl acrylate (EHA), 13.44 g of divinylbenzene, 20.00 g of a 15 wt % strength aqueous solution of Disponil SDS (emulsifier based on sodium lauryl sulphate), 128.2 g of deionized water and 0.26 g of sodium peroxodisulphate. The mixture is stirred vigorously for one minute, stirred vigorously again, after five minutes of rest time, for ten minutes, with stirring being continued until an emulsion has formed.

25.7 g of seed latex from example 1, 0.51 g of a 15 wt % strength aqueous solution of Disponil SDS and 456 g of deionized water are charged to a 1 L flask and heated to an internal temperature of 84-85° C. with stirring (150 rpm) and with nitrogen blanketing. The temperature of the water bath is then kept constant. 2.8 mL of a 10 wt % strength sodium peroxodisulphate solution are added. After a one-minute pause, the monomer mixture for the first reaction stage is metered at a rate of 3.2 g/min. During the 20-minute metered feed, the internal temperature rises to 87° C. Following a twenty-minute after-reaction time, 3 mL of a 10% strength aqueous sodium peroxodisulphate solution are added. After one minute, metering of the emulsion of the second reaction stage is commenced, the feed taking place over 30 minutes at 2.5 g/min. Subsequently the metering rate is increased to 8.0 g/min for 51 minutes. An increase in internal temperature to temperatures greater than 88° C. is neutralized by reducing the water temperature. After a 30-minute after-reaction time, the dispersion is cooled to room temperature and filtered through a 250 μm gauze.

### Example 3

Formulation of a subcritical (meth)acrylate dispersion based on Mowilith 7714 (from Celanese). The millbase (preliminary stage 1) was prepared by charging the water to a vessel and adding all of the further components (see table 1) with stirring. The stirring assembly used was a dissolver with a toothed disc.

TABLE 1
Millbase formulation (preliminary stage 1)

| | | |
|---|---|---|
| Water | 16 | g |
| Tylose H 6000 YP2 | 0.2 | g |
| (Hydroxyethylcellulose) | | |
| TEGO ® Foamex 855 (defoamer) | 0.1 | g |
| Calgon N (10 wt % strength) | 0.2 | g |
| (Dispersing assistant) | | |
| TEGO ® Dispers 755W | 0.3 | g |
| (Dispersing assistant) | | |
| Kronos 2190 (TiO₂) | 19 | g |
| NaOH (aqueous solution, 10 wt % | 0.2 | g |
| strength) | | |
| Texanol (film-forming assistant) | 2.0 | g |
| Total initial mass | 37 | g |

This is followed by letdown.

TABLE 2

| | Comparative example 1 | | Example 3 | |
|---|---|---|---|---|
| Millbase according to | 37 | g | 37 | g |
| preliminary stage 1 | | | | |
| NaOH (aqueous | — | | 2.9 | g |
| solution, 10 wt % | | | | |
| strength) | | | | |
| Water | — | | 2.0 | g |
| Mowilith 7714 | 38 | g | 15.2 | g |
| Hollow bead | — | | 28.5 | g |
| dispersion from | | | | |
| example 2 | | | | |
| Acrysol RM 5000 | 1.0 | g | — | |
| (nonionic thickener) | | | | |
| Total initial mass | 76.0 | g | 85.6 | g |

Comparative example 1 describes a conventional formulation of a subcritical architectural paint with a PVC of around 20%. In analogy to this composition, in example 3, a portion of the Mowilith 7714 binder is replaced by the inventive hollow bead dispersion of example 2 and also by the amount of sodium hydroxide solution required for swelling of the hollow beads (see table 3). This led to a distinct improvement in the water vapour diffusion (s_{D}) relative to comparative example 1, with virtually unchanged gloss and unchanged wet abrasion resistance. From the difference in lightness (ΔL*) by the Gilsonite test it can be shown that both films are not open-pored and that the formulation lies below the critical CPVC.

TABLE 3

| | Comparative example 1 | Example 3 |
|---|---|---|
| pH | 8.7 | 8.3 |
| W₂₄ [kg/(m² * √h)] | 0.01 | 0.04 |
| S_{d} [m] | 0.99 | 0.18 |
| 20° gloss [GU] | 40.3 | 45.0 |
| ASTM (strokes) | 2400 | 2210 |
| Film thickness (ASTM) | 80 μm | 80 μm |
| Gilsonite test (ΔL*) | −0.32 | −0.23 |

### Example 4

### Preparation of a Swollen Hollow Bead Dispersion

The inventive hollow bead dispersion according to example 2 was diluted to 20 wt % with water and the pH was adjusted to 8.5 using 10 wt % strength sodium hydroxide solution.

### Example 5

### Formulation Examples for Clear Varnishes

In this series of experiments, unpigmented dispersion-based varnish was investigated, based on an acrylic/methacrylic ester copolymer dispersion Ecrylic RA 111 from Ecronova.

The dispersions identified in tables 4 and 5 were mixed with one another in the stated ratio and homogenized using a Speedmixer. The figures for the ratio of binder to hollow beads are based on the ratio of the solids contents to one another.

TABLE 4
Formulations of unpigmented dispersion-based varnishes
according to example 5

| | | | | |
|---|---|---|---|---|
| Ratio of binder to hollow | 80:20 | 60:40 | 40:60 | 20:80 |
| bead | | | | |
| Ecrylic RA 111 in g | 16.0 | 12.0 | 8.0 | 4.0 |
| Hollow bead dispersion | 10.0 | 20.0 | 30.0 | 40.0 |
| according to example 4 in g | | | | |
| Total in g | 26.0 | 32.0 | 38.0 | 44.0 |

### Comparative Example 2

In this comparative example, Rhopaque Ultra E from Dow Chemical Company was used. This is a non-film-forming hollow bead dispersion having a particle size of 400 nm, which is neutralized with NaOH. This mixture was prepared as described in example 5.

TABLE 5
Formulations of varnishes according to comparative example 2

| | | |
|---|---|---|
| Ratio of binder to Ropaque | 80:20 | 60:40 |
| Ultra E | | |
| Ecrylic RA 111 in g | 16.0 | 12.0 |
| Ropaque Ultra E in g | 10.0 | 20.0 |
| Total in g | 26.0 | 32.0 |

TABLE 6
Results for example 5 and comparative example 2

| | | Ropaque | | Hollow bead dispersion | | | |
|---|---|---|---|---|---|---|---|
| | | Ultra E | | according to example 4 | | | |
| Ratio of | 100:0 | 80:20 | 60:40 | 80:20 | 60:40 | 40:60 | 20:80 |
| binder to | | | | | | | |
| second | | | | | | | |
| compo- | | | | | | | |
| nent | | | | | | | |
| 20° gloss | 157 | 10.5 | 2.0 | 142 | 128 | 131 | 139 |
| S_{d} [m] | 2.72 | 2.67 | Un- | 1.38 | 0.49 | 0.32 | 0.2 |
| | | | meas- | | | | |
| | | | urable | | | | |
| | | | owing | | | | |
| | | | to | | | | |
| | | | cracks | | | | |
| | | | in film | | | | |

In the example series under example 5 the intention is to show that even in an unpigmented, clear varnish based on the Ecrylic RA 111 binder from Ecronova Polymer, the hollow beads of the invention have an amazing influence on the water vapour permeability. With a hollow bead fraction of just 20 wt %, for example, based on the ratio of the binders, a distinct increase in the water vapour permeability is found when using the hollow bead dispersion, with virtually unchanged gloss. When the fraction of the hollow bead dispersion is increased further, in accordance with example 4, there is a further increase in the water vapour permeability, without significant effect on the gloss of the films.

The Ropaque Ultra E dispersion from Dow is used as comparative example 2. This is a non-film-forming hollow bead dispersion having a particle size of approximately 400 nm, which is neutralized with NaOH. As expected, addition of Ropaque Ultra E with a mixing ratio of 80:20 does not significantly lower the S_{d} figure. Addition of the Ropaque product at a higher level led to cracks in the film, and it was therefore not possible to test the water vapour permeability. The use of the non-film-forming hollow bead dispersion led to a sharp decrease in the gloss, and to the clouding of the film.

1. A method for improving water vapour permeability of a dispersion-based paint or varnish, the method comprising:
introducing at least 3.0 wt % of swollen microparticles into the dispersion-based paint or varnish,
wherein
the microparticles are emulsion polymers with a core-shell structure comprising one or more shells,
the core comprises acid groups, and
an outermost shell has a glass transition temperature of below 50° C.

2. The method according to claim 1, wherein the paint has a pigment volume concentration of below CPVC.

3. The method according to claim 1, wherein the microparticles are swollen at a temperature of below 50° C.

4. The method according to claim 1, wherein
the microparticle has more than one shell, and
at least one inner polymerization stage has a fraction of acid-functional monomers of more than 5 wt %, based on the at least one inner polymerization stage.

5. The method according to claim 1, wherein the emulsion polymers have a diameter of between 30 nm and 1200 nm.

6. The method according claim 1, wherein the emulsion polymers comprise
a polymer core (A) which is swollen via an aqueous base and was prepared with copolymerization of at least one unsaturated, acid-functional monomer, and
a polymer shell (B) which consists predominantly of nonionic, ethylenically unsaturated monomers.

7. The method according to claim 6, wherein the aqueous base comprises at least in part bases having a boiling point of at least 110° C.

8. The method according to claim 6, wherein the at least one unsaturated, acid-functional monomer is at least one of acrylic acid, methacrylic acid, maleic acid, maleic anhydride, fumaric acid, itaconic acid and crotonic acid.

9. The method according to claim 6, wherein the nonionic, ethylenically unsaturated monomers in the polymer shell are acrylates, methacrylates, styrene and/or mixtures composed predominantly of acrylates and/or methacrylates and/or styrene.

10. The method according to claim 6, wherein the polymer shell (B) comprises at least 0.5 wt % of a crosslinking difunctional monomer.

11. The method according to claim 1, wherein the microparticles have a structure in which at least two shells are arranged around the core.

12. The method according to claim 1, further comprising:
subsequently using the dispersion-based paint or varnish as an architectural paint.

13. A dispersion-based paint or varnish comprising:
at least 10.0 wt % of a binder, and
at least 3.0 wt % of swollen microparticles for improving water vapour permeability,
wherein
the microparticles are emulsion polymers with a core-shell structure comprising one or more shells,
the core comprises acid groups, and
an outermost shell has a glass transition temperature of below 50° C.

14. The dispersion-based paint or varnish according to claim 13, wherein the emulsion polymer is a (meth)acrylate-based core-shell particle comprising
an acid-comprising core which is capable to be swollen basically at room temperature, and
a shell having a glass transition temperature of below 50° C.
